(19) United States
(12) Patent Application Publication
(10) Pub. No.: US 2015/0310337 A1
(43) Pub. Date: Oct. 29, 2015

(54) METHOD FOR PROVIDING A PLATFORM FOR BUILDING A DYNAMIC SOCIAL KNOWLEDGEBASE

(71) Applicant: CRMIT SOLUTIONS (I) PVT. LTD., Bangalore (IN)

(72) Inventors: NAGA SUBRAMANIAN CHOKKANATHAN, BANGALORE (IN); VINOD NARAPAREDDY, BANGALORE (IN)

(21) Appl. No.: 14/699,587

(22) Filed: Apr. 29, 2015

(30) Foreign Application Priority Data
Apr. 29, 2014 (IN) 2157/CHE/2014

(51) Int. Cl. G06N 5/04; H04L 29/08

(52) U.S. Cl. CPC G06N 5/04; H04L 67/10; H04L 67/22

(57) ABSTRACT

The present invention provides a method and system for providing a platform for building a dynamic social knowledgebase. The method includes importing a traditional knowledgebase from an entity at regular intervals, receiving login credentials from a user via a web portal or mobile application. Retrieving social knowledgebase from a social network associated with the user, providing recommendations to the user based on articles that are more clickable in the traditional knowledgebase and the social knowledgebase, sending a notification to the user based on the latest happenings in the web portal or mobile application, monitoring a list of top contributors and influencers of the social knowledgebase in the social network associated with the user, and sending the list of top contributors and influencers to a backend system for analysis & use.

### RELATED APPLICATIONS

This application claims the benefit of Indian provisional patent application no. 2157/CHE/2014, titled ‘A method and system for customer relationship management using dynamic social knowledgebase’ filed on 29 Apr. 2014. The same has been incorporated herein by reference.

### FIELD OF THE INVENTION

The present invention relates to the field of customer relationship management, and in particular, it relates to using dynamic social knowledgebase for customer relationship management. This knowledgebase may contain articles, information about products, customers and the like.

### BACKGROUND OF THE INVENTION

Customer Relationship Management (CRM) refers to a model for managing a company's interactions with current and future customers. CRM is a vital component of any company. CRM involves using conventional technology to streamline various aspects of the company's interaction with the current and future customers. The various aspects include but may not be limited to sales, marketing, customer service, and social presence. In particular, customer support and technical service plays a decisive role in attracting the current customers for giving additional business.

With passage of time and growth in technology, CRM has evolved to give the customers an experience like never before. In today's world, the companies make every effort to acquire and retain customers starting from giving excellent after-sales service to customized customer care. Such services consume a huge chunk of the company's fund. This in turn leads to increase in cost by the company, which is adverse to the customer's expectations.

With increase in popularity of the Internet, many companies have started using web-based portals to provide customer support. There is a host of benefits associated with the web-based customer support portals. The web-based customer support portals allow the customers to register their product, which further helps the customers to view various features of the product as well as the product history easily. Additionally, web-based portals allow the customers to know about new products and services matching requirements of the customers. In addition, the web-based customer support portals are economic as compared to call centers and physical visit of an executive of the company. Additionally, the web-based customer support portals provide a greater degree of trust and reliability, since all the data is in the written form instead of being verbal. An important advantage of the web-based customer support portals is accessibility. The customer is able to access the required topic from any place and at any point of time. Further, the privacy of the customer is maintained, since the customer is not required to share the phone number of the customer.

With the above-mentioned advantages, the web-based customer support portals have some disadvantages. The material that is provided to the customers is mostly static, with very little or no change in the material over a period. With the exponential growth in technology, current technologies are becoming obsolete at a very fast rate. In such a scenario, the static materials provided on the web-based customer support portals lose their importance over a short period. In addition, it is difficult for the customer to search for the information relevant to the customer. Additionally, the customer may be facing a problem with a product. In case the customer cannot find any relevant article in the customer support portals, the customer is left with no other option than to take the long route of contacting the company, which is inconvenient for the customer and the company. The customer has to spend time and resources to get to the right person in the company. On the other hand, the right person has to spend a considerable amount of time in addressing the query of the customer. Such a process increases the overall cost of support.

In light of the above discussion, there is a need for a dynamic social knowledgebase for improving support and hence, overall customer relationship management.

### BRIEF DESCRIPTION OF THE INVENTION

The above-mentioned shortcomings, disadvantages and problems are addressed herein which will be understood by reading and understanding the following specification.

In various embodiments, the present invention provides a method for providing a platform for building a dynamic social knowledgebase. The method includes importing a traditional knowledgebase (such as articles, product information, customer information, dealer information and the like) from an entity at regular intervals, receiving login credentials from a user via a web portal or mobile application, retrieving social connections from a social network associated with the user with the user's permission, providing recommendations to the user based on articles that are more clickable in the traditional knowledgebase and the social knowledgebase, sending a notification to the user based on the latest happenings in the web portal or mobile application, monitoring a list of top contributors and influencers of the social knowledgebase in the social network associated with the user, and sending the list of top contributors and influencers to a backend system.

In another aspect, the present invention provides a system for providing a platform for building a dynamic social knowledgebase. The system includes an import module, a receiving module, a retrieval module, a recommendation module, a notification module, a monitoring module, a transmission module, and a submission module. The import module is configured to import a traditional knowledgebase (such as articles, product information, customer information, dealer information and the like) from an entity, the receiving module is configured to receive login credentials from a user, the retrieval module is configured to retrieve social connections from a social network associated with the user with the user's permission, the recommendation module is configured to provide recommendations to the user, the notification module is configured to send a notification to the user, the monitoring module is configured to monitor a list of top contributors and influencers of the social knowledgebase in the social network associated with the user, the transmission module is configured to send the list of top contributors and influencers to a backend system and the submission module is configured to allow user to submit their new knowledge articles to the existing social knowledgebase, which may be approved by the entity before they are visible to others in the web portal or Mobile Application.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 illustrates a system for providing a platform for building a dynamic social knowledgebase, in accordance with embodiments of the present invention;

FIG. 2 illustrates a block diagram of a the dynamic social knowledgebase, in accordance with embodiments of the present invention; and

FIGS. 3A and 3B illustrate a flowchart for providing the platform for building the dynamic social knowledgebase, in accordance with various embodiments of the present invention.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

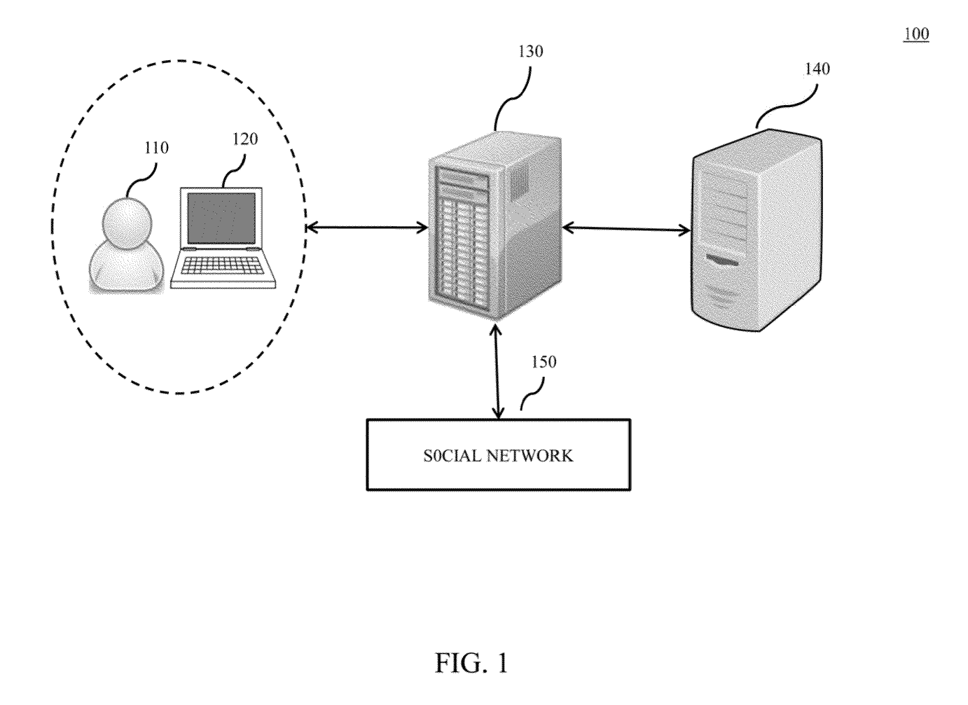

FIG. 1 illustrates a system 100 for providing a platform for building a dynamic social knowledgebase 130, in accordance with embodiments of the present invention. The system 100 includes a user 110 associated with a computing device 120, the dynamic social knowledgebase 130, a data server 140 and a social network 150.

In context of the present invention, the user 110 refers to a person using the system or method of the present invention.

In context of the present invention, the computing device 120 refers to any electronic device that has both wireless phone/network capability and the capability to run/support software applications. Examples of the one or more computing devices 120 and the one or more computing devices 160 are, but may not be limited to cell phones, smart phones, Personal Data Assistants (PDA), laptops, desktops, smart watches.

In context of the present invention, the dynamic social knowledgebase server 130 refers to a computer, an electronic or processing device or a server operable to receive, process and communicate data received from the data server 140 and the social network 150.

In context of the present invention, the data server 140 refers to a computer, an electronic or processing device or a server of the entity that stores traditional knowledgebase related to the entity. The traditional knowledgebase includes at least one of product catalogues, frequently asked questions, usage instructions, trouble shooting tips, customer reviews, visual tours, customer information, dealer information, videos, links and the like.

The dynamic social knowledgebase server 130 imports traditional knowledgebase from the data server 140 of an entity. The traditional knowledgebase includes, but may not be limited to, product catalogues, frequently asked questions, usage instructions, trouble shooting tips, customer reviews, visual tours, customer information, dealer information, videos, links and the like. The dynamic social knowledgebase server 130 stores the received traditional knowledgebase in a data repository (not shown in the figure). In addition, it is also possible for user 110 to add knowledge to this knowledgebase as allowed by the entity.

The user 110 interacts with the dynamic social knowledgebase server 130 to gain knowledge. The knowledge pertains to general information about the entity, information about a product of the entity that the user 110 intends to purchase in future, usage information about a product owned by the user 110, customer information, dealer information, and the like. Additionally, the knowledge includes installation instructions, safety precautions, blue print of an internal circuitry of the product in some cases, and the like.

Further, the dynamic social knowledgebase server 130 interacts with the social network 150. In context of the present invention, the social network 150 is a public social network. Examples of the public social network are Facebook, Twitter, LinkedIn etc. The interaction is done upon receiving permission from the user 110. The dynamic social knowledgebase sever 130 interacts with the social network 150 of the user 110 to identify groups, patterns and influencers. Further, the dynamic social knowledgebase server 130 interacts with the social network 150 of the user 130 to identify relationship of the user 110 with fellow customers. Such interaction is used to effectively target the right things to the user 110. It is to be noted that there may be more than one social network system 150 that interacts with dynamic social knowledgebase 130, collating all these information to provide better experience to user 110.

In an example, the user 110 is a customer of a financial organization and the dynamic social knowledgebase server 130 is a data server of the financial organization. The financial organization stores general information about the financial organization in the dynamic social knowledgebase server 130. In addition, the financial organization stores information about products and services offered by the financial organization, Frequently Asked Questions (FAQs), details about service charges and fees, and new products launched by the financial organization in the dynamic social knowledgebase server 130. The customer interacts with the dynamic social knowledgebase server 130 using the user 110 interface to gain knowledge about products and services offered by the financial organization in addition to knowledge about the financial organization.

In another example, the user 110 is a prospective buyer of a car and the dynamic social knowledgebase server 130 is a server of the car manufacturer. The car manufacturer feeds information about different models produced by the car manufacturer. The prospective buyer browses through the information available on the dynamic social knowledgebase server 130 to choose a car model suitable for the prospective buyer. Further, the prospective buyer browses through the information available on the dynamic social knowledgebase server 130 to gain more knowledge about the chosen car model. Further, in case of unavailability of a particular information required by the prospective buyer, the prospective buyer initiates a discussion. An executive of the car manufacturer answers the query of the prospective buyer. Alternatively, a fellow car owner answers the query of the prospective buyer. A prospective buyer can look for dealer information where they can make a purchase. As a result, the prospective buyer is saved from the harassment of searching for the particular string of information. Additionally, the prospective buyer is given the right of making an informed decision.

The dynamic social knowledgebase 130 communicates with the user 110, the data server 140 and the social network 150 using a communication network (not shown in the figure). Examples of the communication network are, but may not be limited to a local area network, a wide area network, a wireless network, a telecommunication network. Types of the telecommunication network are, but may not be limited to a global system for mobile communication (GSM) network, a general packet radio service (GPRS) network, a code division multiple access (CDMA) system, an enhanced data GSM environment (EDGE), a wideband CDMA (WCDMA).

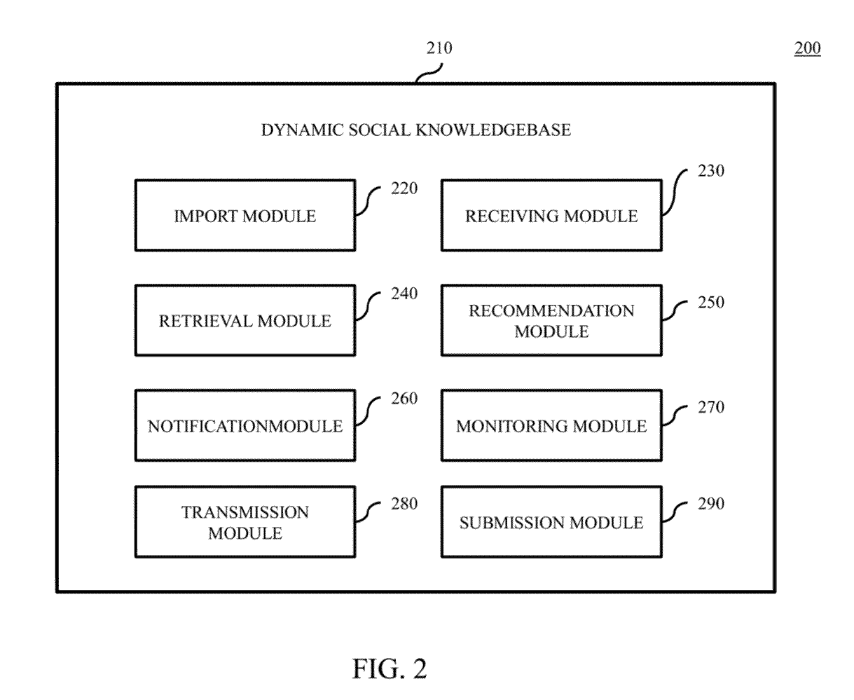

FIG. 2 illustrates a block diagram 200 of a dynamic social knowledgebase 210, in accordance with embodiments of the present invention. The dynamic social knowledgebase 210 includes a import module 220, a receiving module 230, a retrieval module 240, a recommendation module 250, a notification module 260, a monitoring module 270, a transmission module 280 and a submission module 290.

The import module 220 of the dynamic social knowledgebase server 210 imports the traditional knowledgebase from the entity. The import module 220 imports the traditional knowledgebase at regular intervals from the data server 140 of the entity. The traditional knowledgebase includes, but may not be limited to, product catalogues, frequently asked questions, usage instructions, trouble shooting tips, customer reviews, visual tours, customer information, dealer information, videos, links and the like. The dynamic social knowledgebase server 210 stores the received traditional knowledgebase in a data repository (not shown in the figure).

The receiving module 230 of the dynamic social knowledgebase 210 receives login credentials from the user 110. The receiving module 230 receives the login credentials via the web portal or mobile application. The user 110 uses the computing device 120 associated with the user 110 to input the login credentials. Examples of the computing device 120 are a desktop computer, a laptop computer, a tablet computer, a handheld mobile device, and the like. The login credentials include at least one of a username, first name, last name, contact number, email id, date of birth, and an alphanumeric password. The login credentials are provided by the user 110 at the time of signing up on the web portal or mobile application. The login credentials may be stored in the dynamic social knowledgebase server 210 or in a system such as CRM, SSO and the like (not shown in the figure). On subsequent login, the user 110 provides at least one login credentials to the dynamic social knowledgebase server 210 through the web portal or mobile application. For example, the user 110 provides the username and password of the user 110 to the dynamic social knowledgebase server 210 through the web portal or mobile application. Alternatively, the user 110 provides the contact number of the user 110 to the dynamic social knowledgebase server 210 through the web portal or mobile application. This entire flow may be simplified by using the Social Network (Public) profiles such as “Facebook Profile”, “LinkedIn Profile” etc. In this case, the user 110 provides permission to the dynamic social knowledgebase server 210 to use public social profile of the user 110 from the social network 150.

The retrieval module 240 of the dynamic social knowledgebase server 210 retrieves the social connections from the social network 150 associated with the user 110. The social connections comprise at least one or more friendships, group memberships and the like. The social connection information is retrieved upon receiving an approval from the user into the dynamic social knowledgebase server 210.

The recommendation module 250 of the dynamic social knowledgebase server 210 provides recommendations to the user 110 using the information on their social connections. The recommendations are based on articles that are more clickable in the traditional knowledgebase and the social knowledgebase. Further, the recommendation module 250 sends the recommendations to the user 110 by at least one of text, image, video format.

The notification module 260 of the dynamic social knowledgebase server 210 sends the notification to the user 110. The notification includes the latest happenings in the web portal or mobile application. The notification module 260 sends the notifications to the user 110 by at least one of in the web portal, mobile application, E-mail, message on the social network 150 associated with the user 110.

The monitoring module 270 of the dynamic social knowledgebase server 210 monitors the list of top contributors and influencers of the social knowledgebase in the social network 150 associated with the user 110.

The transmission module 280 of the dynamic social knowledgebase server 210 sends the list of top contributors and influencers to a backend system. The backend system may provide targeted campaigns and call center services to the user 110. Business users may use this information to get useful analytics and intelligence.

The submission module 290 of the dynamic social knowledgebase server 210 allows the user 110 to write articles to the dynamic social knowledgebase which can be reviewed, voted by other users in the system.

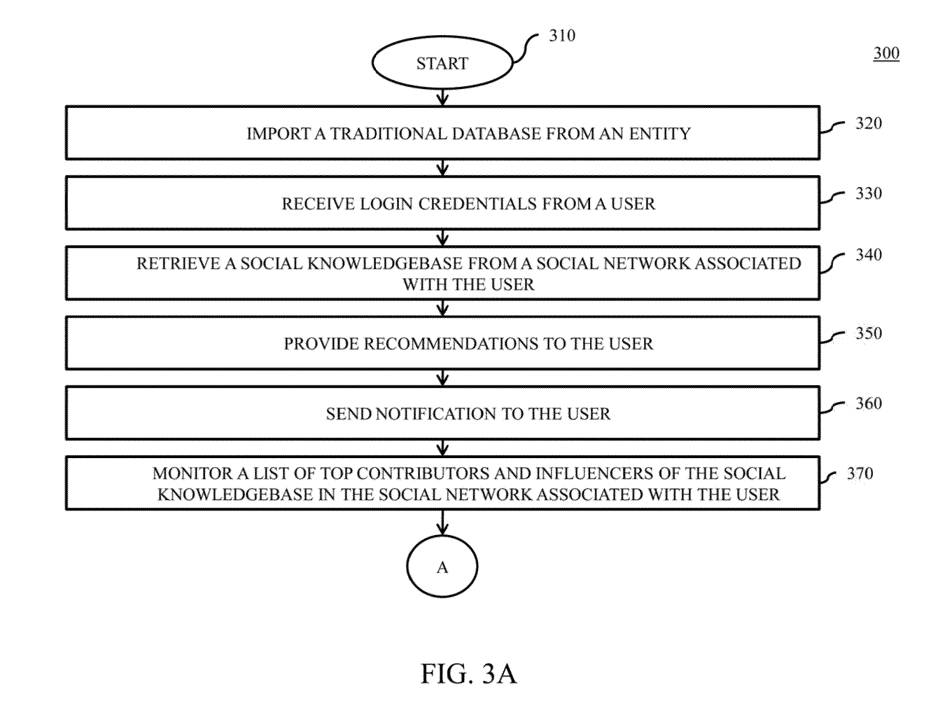

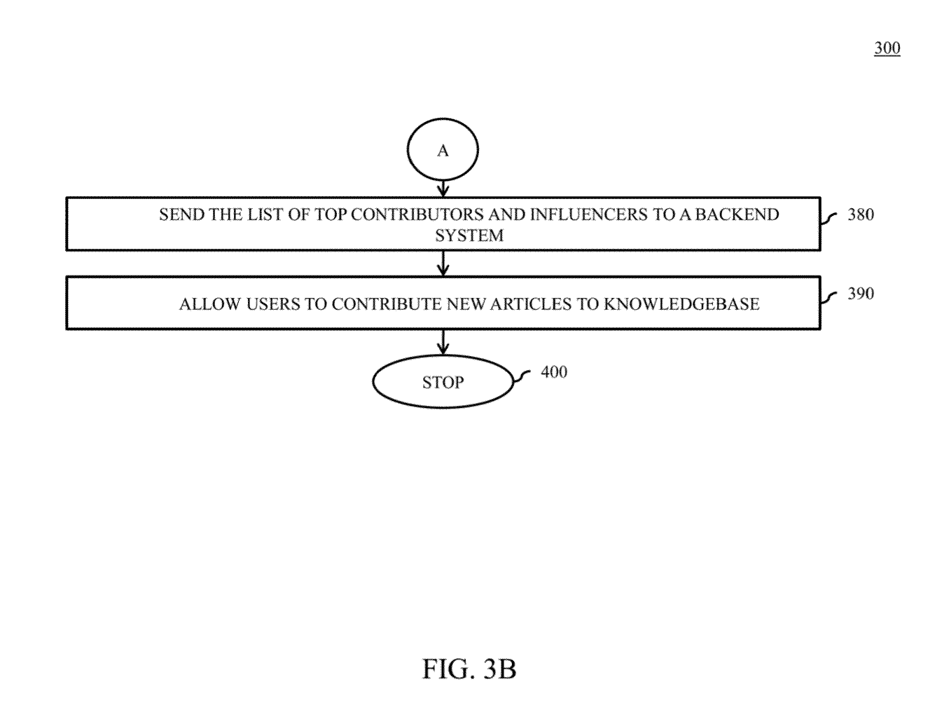

FIGS. 3A and 3B illustrate a flowchart 300 for providing the platform for building the dynamic social knowledgebase 130, in accordance with various embodiments of the present invention.

At step 310, the flowchart initiates. At step 320, the dynamic social knowledgebase server 130 imports the traditional knowledgebase from the entity. The traditional knowledgebase is automatically imported at regular intervals from the entity. At step 330, the dynamic social knowledgebase server 130 receives login credentials from the user 110. The login credentials are received via the web portal or mobile application or social network. The dynamic social knowledgebase server 130 authenticates the user 110. The authentication of the user 110 is done to prevent fraudulent usage of an account of the user 110 created on the dynamic social knowledgebase server 130. For example, the dynamic social knowledgebase server 130 checks the received username and password against a plurality of usernames and a plurality of passwords stored in the dynamic social knowledgebase server 130. On a successful match of the username and the password, the user 110 is deemed to be a valid user. Alternatively the dynamic social knowledgebase server 130 sends a validation code to the contact number of the user 110. The web portal or mobile application asks the user 110 to enter the validation code. The user 110 enters the validation code into the web portal or mobile application, which is passed onto the dynamic social knowledgebase server 130. On a successful match of the validation code sent to the user 110 and the validation code entered by the user 110, the user 110 is deemed to be a valid user. Alternatively, the web portal or mobile application sends a signal to the social network 150 requesting to authenticate the user 110. On a successful authentication, the user 110 is deemed to be a valid user.

At step 340, the dynamic social knowledgebase server 130 retrieves the social connections from the social network 150 associated with the user 110. The social connections comprises at least one or more friendships, group memberships and the like. The social connection information is retrieved upon receiving an approval from the user.

At step 350, the dynamic social knowledgebase server 130 provides recommendations to the user 110. The recommendations are based on articles that are more clickable in the traditional knowledgebase and the social knowledgebase. The articles that are more clickable are based on one or more parameters. The one or more parameters are at least one of keywords, context, trends, (user's personal) social network reading preferences/feedback (View/soft/hard recommendation/comments).

At step 360, the dynamic social knowledgebase server 130 sends the notification to the user 110. The notification includes the latest happenings in the web portal or mobile application. At step 370, the dynamic social knowledgebase server 130 monitors the list of top contributors and influencers of the social knowledgebase in the social network 150 associated with the user 110. At step 380, the dynamic social knowledgebase server 130 sends the list of top contributors and influencers to the backend system. The backend system may provide targeted campaigns and call center services to the user 110 based on the data received from the dynamic social knowledgebase server 130 or it can provide analytics to business based on this data. At step 390, the dynamic social knowledgebase server 130, through its web portal or Mobile App allows the user 110 to contribute to the growth of the social knowledgebase. At step 395, the flowchart 300 terminates.

For example, upon successful login, the user 110 is allowed to browse through the articles already present in the dynamic social knowledgebase server 130. In an embodiment, the dynamic social knowledgebase server 130 stores data about preferences of the user 110 and the publicly available social network particulars of the user 110. On successful login, the web portal or Mobile Application shows most relevant articles to the user 110 based on the preferences of the user 110. In another embodiment, the user 110 conducts a search to find an article relevant to the user 110 at a particular point of time. The web portal or mobile application displays other articles similar to the article searched for by the user 110. In addition, the web portal or mobile application displays articles read by social friends and followers of the user 110. Therefore, the user 110 gets access to other articles that may be of interest to the user 110. The user 110 may read the article, comment on the article, suggest changes, add feedback, and share it with other users.

Contrarily, the user 110 searches for an article, but if the article is not available on the dynamic social knowledgebase server 130. Then, the user 110 gathers information from a different source and writes the information as an article. Others users have the option of rating the feed based on certain parameters. The parameters include, but may not be limited to, relevancy, quality, similarity to other articles, and overall content. Simultaneously, the article written by the user 110 may also be sent to the entity for review. The entity has the authority to validate the article. On validation of the article, the article is retrieved by the dynamic social knowledgebase server 130 at step 340.

In an embodiment, the web portal or mobile application is a social networking website or mobile application, focused on customer relationship, providing support. The user 110 creates an account of the website or mobile application. The website or mobile application has a group for each entity registered with the website or mobile application. The group has a plurality of users. In general, the users are at least one of current customers of the entity, future customers of the entity, employees of the entity, vendors of the entity, and users interested in the entity. The group provides a platform for the entity to inform the users about various new products, updates, and support. On logging into the website or mobile application, the user 110 is given the option to join the group of the entity. Additionally, the user 110 is allowed to discuss an article present in the group with other users present in the group. Such groups may be public or private. Public groups are accessible to any user of the website or mobile application. The user 110 needs permission to join private groups. User 110 can read articles, rate them, share them, comment on them or write new articles.

The present invention enables a company to boost service quality and sales. The company can analyze the data on the dynamic social knowledgebase to determine the topics being discussed frequently by the customers and use Predictive Analytics techniques to understand the trend and to make business decisions. Additionally, the discussions are scrutinized to understand the demands of the customers. As a result, new products are developed or existing products are targeted through marketing channels to specific, small segments of users. Further, the company can use the web portal or mobile application to introduce new products to the customers. Hence, sales and marketing is improved.

The present invention makes data sharing easier and seamless. In addition, the present invention enables customers to gain information about answers to their problems and about the products of their choice with lesser effort as compared to traditional methods of getting product knowledge. Further, the present invention provides companies with a platform to interact with customers and resolve the queries of the customers at a smaller cost, without the need of a dedicated call center for handling every issue. Furthermore, the present invention allows customers to gain knowledge about products of the entity that are being discussed about by other customers. Finally, the present invention makes an effort to bring the customer and the entity to the same platform in order to increase interaction.

It should be understood that the foregoing pertains only to the exemplary embodiments of the present invention, and that numerous changes may be made to the embodiments described herein without departing from the spirit and scope of the invention.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for providing a platform for building a dynamic knowledgebase, the method comprising:
a. importing a traditional knowledgebase from an entity, wherein the traditional knowledgebase is imported at regular intervals;
b. receiving login credentials from a user, wherein the login credentials are received via at least a web portal or a mobile application;
c. retrieving social knowledgebase from a social network associated with the user, wherein the social knowledgebase comprises at least one of one or more articles created by the user, comments on the one or more articles, wherein the social knowledgebase information is retrieved upon receiving an approval from the user;
d. providing recommendations to the user, wherein the recommendations are based on articles that are more clickable in the traditional knowledgebase and the social knowledgebase;
e. sending a notification to the user, wherein the notification comprises the latest happenings in at least the web portal or the mobile application;
f. monitoring a list of top contributors and influencers of the social knowledgebase in the social network associated with the user; and
g. sending the list of top contributors and influencers to a backend system, wherein the backend system provides targeted campaigns and call center services to the user.
h. allowing users to submit articles for the growth of the social knowledgebase.

2. The method as claimed in claim 1, wherein the traditional knowledgebase comprises at least one of product catalogues, frequently asked questions, usage instructions, trouble shooting tips, customer reviews, visual tours, customer information, dealer information, videos and URLs.

3. The method as claimed in claim 1, wherein the login credentials are received upon the user inputting the login credentials into the web portal or the mobile application on a communication device associated with the user.

4. The method as claimed in claim 1, wherein the login credentials are fetched from a social network profile associated with the user, wherein the login credentials are fetched upon receiving approval from the user.

5. The method as claimed in claim 1, wherein the recommendations are at least one of text, image, video.

6. The method as claimed in claim 1, wherein the articles that are more clickable are based on one or more parameters.

7. The method as claimed in claim 6, wherein the one or more parameters are at least one of keywords, context, trends, (user's personal) social network reading preferences/feedback (View/soft/hard recommendation/comments).

8. The method as claimed as in claim 1, wherein the notifications are sent to the user by at least one of in the web portal, mobile application, E-mail, message on the social network associated with the user.

9. A system for providing a platform for building a dynamic knowledgebase, the system comprising:
a. an import module, wherein the import module is configured to import a traditional knowledgebase from an entity, wherein the import module imports the traditional knowledgebase at regular intervals;
b. a receiving module, wherein the receiving module is configured to receive login credentials from a user, wherein the receiving module receives the login credentials via a web portal or mobile application;
c. a retrieval module, wherein the retrieval module is configured to retrieve a social knowledgebase from a social network associated with the user, wherein the social knowledgebase comprises at least one of one or more articles created by the user, comments on the one or more articles, wherein the social knowledge is retrieved upon receiving an approval from the entity;
d. a recommendation module, wherein the recommendation module is configured to provide recommendations to the user, wherein the recommendations are based on articles that are more clickable in the traditional knowledgebase and the social knowledgebase;
e. a notification module, wherein the notification module is configured to send a notification to the user, wherein the notification comprises the latest happenings in the web portal or mobile application;
f. a monitoring module, wherein the monitoring module is configured to monitor a list of top contributors and influencers of the social knowledgebase in the social network associated with the user; and
g. a transmission module, wherein the transmission module is configured to send the list of top contributors and influencers to a backend system, wherein the backend system provides targeted campaigns and call center services to the user.
h. a submission module, wherein the submission module is configured to allow the user to write articles and contribute to the growth of the social knowledgebase.

10. The system as claimed in claim 9, wherein the recommendations sent by the recommendation module are at least one of text, image, video.

11. The system as claimed as in claim 9, wherein the notification module sends the notifications to the user by at least one of in the web portal, mobile application, E-mail, message on the social network associated with the user.
